(19) United States
(12) Patent Application Publication
(10) Pub. No.: US 2014/0042234 A1
(43) Pub. Date: Feb. 13, 2014

(54) SYSTEM, APPARATUS AND METHOD FOR QUICK WARM-UP OF A MOTOR VEHICLE

(71) Applicants: George Moser, Brighton, MI (US); Adam Ostapowicz, Orchard Lake Village, MI (US); Lawrence C. Kennedy, Baldwin, MI (US); David Kolton, Howell, MI (US)

(72) Inventors: George Moser, Brighton, MI (US); Adam Ostapowicz, Orchard Lake Village, MI (US); Lawrence C. Kennedy, Baldwin, MI (US); David Kolton, Howell, MI (US)

(73) Assignee: COOPER-STANDARD AUTOMOTIVE, INC., Novi, MI (US)

(21) Appl. No.: 13/570,725

(22) Filed: Aug. 9, 2012

(51) Int. Cl. B60H 1/20; F01N 5/02

(52) U.S. Cl. 237/12.4; 60/320

(57) ABSTRACT

A system for quick warm-up of a motor vehicle having an engine, an exhaust system and a passenger cabin includes a heat collector disposed in the exhaust system downstream of the catalytic converter. The system additionally includes a heater core in the passenger cabin. The heater core is in fluid communication with the heat collector for receiving a heated fluid from the heat collector. The system further includes an expansion tank for receiving fluid from the heater core. The expansion tank is located below the heat collector such that fluid drains from the heat collector back to the expansion tank solely under gravitational force. The heat collector may be combined with a resonator or with a muffler. The heater core may be a combined heater core that extracts heat from both the exhaust system and the engine.

### FIELD

The present teachings generally pertain to a system and apparatus for quick warm-up of a motor vehicle. The present teachings also pertain to a related method for quick warm-up of a motor vehicle.

### BACKGROUND

This section provides background information related to the present disclosure which is not necessarily prior art.

Motor vehicles are operated in a wide range of ambient temperatures. Thermal comfort within a passenger cabin is very important for today's motor vehicles. Modern vehicles include HVAC (heating, ventilating and cooling) systems to handle passenger comfort. Until the motor vehicle sufficiently warms during operation in lower ambient temperatures, the vehicle passengers may be cold and the windows may be frosted for several minutes. Furthermore, operation of a motor vehicle in cooler ambient conditions is less efficient. For example, the engine may produce a greater amount of noxious gases and the transmission may operate less than optimally.

FIG. 1 illustrates a prior art system for delivering heat to a passenger cabin. In a conventional motor vehicle, heat is extracted from the engine and directed to a heater core disposed within the passenger compartment. The heater core is in fluid communication with a radiator and the engine of the vehicle. A pump operates to circulate heated fluid (e.g., coolant) from the engine to both the heater core and the radiator. Heat is extracted from the fluid by both the radiator and the heater core. The pump further operates to circulate the cooled fluid from both the radiator and the heater core back to the engine for further cooling of the engine.

Upon start-up of the vehicle, a period of time is required to sufficiently heat the coolant and resultantly provide heat to the passenger cabin through the heater core. With cooler ambient conditions, the period of time increases. As a result, a passenger in the passenger cabin may be required to wait several minutes before appreciable heat may be delivered to the passenger compartment and before the windshield may be defrosted.

In addition to a vehicle engine, another source of heat in a motor vehicle is the exhaust system. A conventional exhaust system for a motor vehicle is schematically illustrated in FIG. 2. The exhaust system operates to process exhaust or exhaust gases from the vehicle engine and direct the exhaust away from the passenger cabin of the vehicle. The exhaust system is shown to generally include a catalytic converter and a muffler. The exhaust system may also optionally include a resonator. A manifold (not shown) typically collects exhaust from the cylinders of the engine and routes the exhaust gas to a single pipe. The exhaust is initially received by the catalytic converter.

The catalytic converter converts noxious emissions into less harmful emissions before the exhaust leaves the exhaust system. A typical catalytic converter employs a reduction catalyst and an oxidation catalyst. Both catalysts generally consist of a ceramic structure coated with a metal catalyst. The metal catalyst is generally platinum, rhodium and/or palladium. The reduction catalyst reduces NOx emissions. The oxidation catalyst reduces unburned hydrocarbons and carbon monoxide by burning (i.e., oxidizing) them over a platinum and/or palladium catalyst. A catalytic converter performs at extremely high temperatures. Temperatures of exhaust exiting the catalytic converter may reach or exceed 600 degrees Fahrenheit.

Where present, the exhaust exiting the catalytic converter may next enter the resonator. The resonator includes a resonator chamber for tuning a sound of the exhaust.

The exhaust exiting the resonator is directed along the exhaust path to one or more mufflers. The muffler functions to reduce the amount of noise emitted by the exhaust system. Finally, exhaust from the muffler passes through a tailpipe.

To a limited extent, it has been heretofore proposed to extract heat from a vehicle exhaust system and deliver the extracted heat to the passenger cabin. It has not been possible to successfully commercialize such prior proposals given the various associated disadvantages. These disadvantages include both cost and safety.

Accordingly, a continuous need for improvement remains in the pertinent art. In this regard, it is desirably to harness the heat of a vehicle exhaust system to safely and quickly warm a passenger compartment for passenger comfort and convenience and perhaps also warm the engine and transmission for improved vehicle operation.

### SUMMARY

In accordance with one particular aspect, the present teachings provide a system for quick warm-up of a motor vehicle. The motor vehicle has an engine, a passenger cabin and an exhaust system. The system includes a heat collector disposed in the exhaust system. The system additionally includes a heater core in proximity of the passenger cabin. The heater core is in fluid communication with the heat collector for receiving a heated fluid from the heat collector. The system further includes an expansion tank for receiving fluid from the heater core. The expansion tank is located below the heat collector such that fluid drains from the heat collector back to the expansion tank solely under gravitational force.

In accordance with another particular aspect, the present teachings provide an apparatus for quick warm-up of a motor vehicle having an engine and a passenger compartment. The apparatus includes a housing defining a chamber. An exhaust path extends from an exhaust input port to an exhaust output port and passes through the chamber. A heat collector is disposed in the chamber and is operative to extract heat from exhaust of the motor vehicle. The heat collector is in fluid communication with a heater core. The chamber may be a resonating chamber.

In accordance with yet another particular aspect, the present teachings provide a combination heater core. The combination heater core includes a first portion for extracting heat from a first heat source and a second portion for extracting heat from a second heat source. The first heat source may be exhaust from an engine of the motor vehicle. The second heat source may be the engine.

In accordance with still yet another particular aspect, the present teachings provide a method for quick warm-up of a motor vehicle having an engine, an exhaust system and a passenger compartment. The method includes providing a heat collector and circulating coolant through the heat collector to extract heat from exhaust of the engine. The method additionally includes stopping the circulation of the coolant and draining the coolant from the heat collector solely under gravitational force.

In accordance with even yet a further particular aspect, the present teachings provide a heat collector for extracting heat from an exhaust system of a motor vehicle and delivering the extracted heat to a passenger cabin. The exhaust system defines an exhaust path for exhaust produced by the motor vehicle. The heat collector includes an outer cylindrical wall and an inner cylindrical wall. The inner cylindrical wall is spaced apart from the outer cylindrical wall to define a heat collector fluid path therebetween. The inner cylindrical wall circumferentially surrounds the exhaust path. An inlet is in fluid communication with the heat collector fluid path and is adapted to fluidly communicate with a heater core of the vehicle. An outlet is in fluid communication with the heat collector fluid path and is adapted to fluidly communicate with the heater core of the vehicle.

In accordance with still yet another aspect of the present teachings, a system for quick warm-up of a motor vehicle having an engine, an exhaust system, a radiator and a passenger cabin includes one or more valves for selectively controlling a flow of coolant from the radiator to the heater core, from the heat collector to the heater core, from the heater core to the radiator, and from the heater core to the expansion tank.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic view of a prior art system for providing heat to a cabin of a motor vehicle.

FIG. 2 is a schematic view of a prior art exhaust system for a motor vehicle.

FIG. 3 is a schematic view of a system for quick warm-up of a motor vehicle construction in accordance with the present teachings.

FIG. 3A is a partially cut-away view of the heat collector of FIG. 3.

FIG. 4 is a schematic view of another system for quick warm-up of a motor vehicle construction in accordance with the present teachings.

FIG. 5 is a perspective view of a combination heater core constructed in accordance with the present teachings.

FIG. 6 is an exploded perspective view of another combination heater core constructed in accordance with the present teachings.

FIG. 7 is a top view of the combination heater core of FIG. 7.

FIG. 8 is a partially cut-away perspective view of an apparatus for quick warm-up of a motor vehicle.

FIG. 9 is a schematic view of another system for quick warm-up of a motor vehicle construction in accordance with the present teachings.

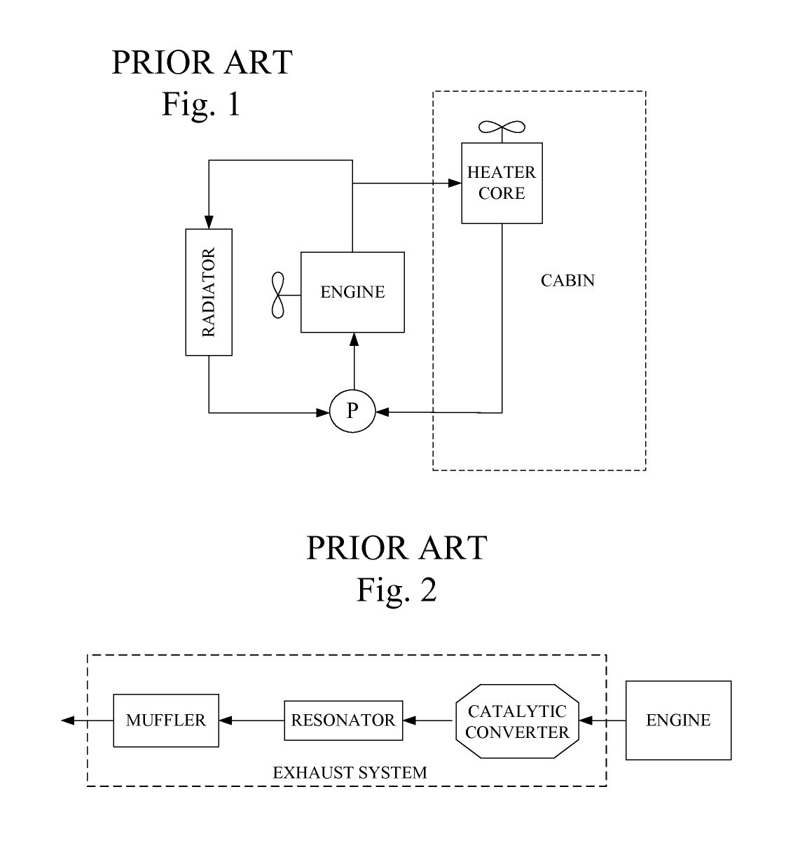

### DETAILED DESCRIPTION OF VARIOUS ASPECTS

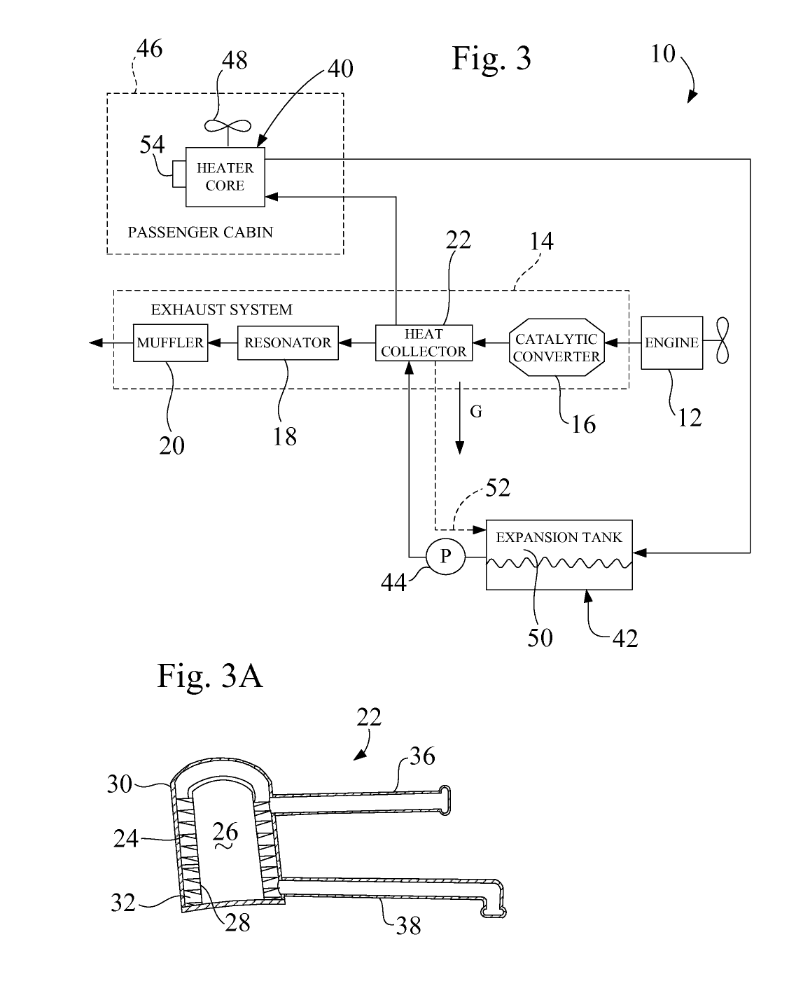

With reference to FIG. 3, a system for providing heat to a passenger cabin of a motor vehicle constructed in accordance with the present teachings is illustrated and generally identified at reference character 10. The system 10 is shown operatively associated with an engine 12 of a motor vehicle and an exhaust system 14 of the motor vehicle. The exhaust system 14 is generally shown to include a catalytic converter 16, a resonator 18 and a muffler 20. To the extent not otherwise described herein, it will be understood that the catalytic converter 16, the resonator 18 and the muffler 20 are conventional in both construction and operation.

The system 10 is illustrated to generally include a heat collector 22. The heat collector 22 is located downstream from the catalytic converter 16 and is operative to extract heat from the heated exhaust. While the heat collector 22 may be located at various points in the exhaust system 14, the heat collector 22 is preferably located immediately after the catalytic converter 16. In this location downstream from the catalytic converter 16, the heat collector 22 does not adversely impact the operation of the catalytic converter 16 but otherwise is able to extract heat from the exhaust at the hottest location of the exhaust.

The construction of the heat collector 22 will be described with reference to FIG. 3A. As generally illustrated, the heat collector 22 may include a jacket 24 for circumferentially surrounding a pipe extending from the catalytic converter 16. The jacket 24 may be generally tubular in shape and may define an inner cavity 26 sized to receive the pipe. The jacket 24 may include an inner wall 28 radially spaced from an outer wall 30. The inner wall 28 directly receives heat from the pipe extending from the catalytic converter. A chamber or fluid path 32 may be defined between the inner and outer walls 28 and 30.

A heat absorbing arrangement may be disposed in the fluid path 32 of the heat collector 22. The heat absorbing arrangement may include a plurality of fins 34. The fins 34 may be constructed of a suitable metal for receiving heat from the inner wall 28 and transferring a portion of the heat to the outer wall 30. As will be appreciated below, the fins 34 may operate to more efficiently transfer heat from the exhaust to a fluid passing through the fluid path 32.

The heat collector 22 is further illustrated to generally include an inlet 36 and an outlet 38. The inlet and outlet 36 and 38 are in fluid communication with the fluid path 32 of the heat collector 22. The inlet 36 is also in fluid communication with a heater core 40 for receiving a cooled fluid (i.e., coolant) from the heater core 40. In the embodiment illustrated, the fluid may be propylene glycol or similar fluid that prevents freezing at ambient temperatures below 32 degrees Fahrenheit an also has a relatively high boiling point.

The outlet 38 is also in fluid communication with an expansion tank 42 and a pump 44 for routing coolant warmed by the heat collector 22 back to the heater core 40. The pump may be a small, low cast 12 VDC pump that operates by a thermostatic switch with a normally off circuit. In the embodiment illustrated, the pump is a centrifugal pump or any other known type of pump that allows significant back flow when not in use.

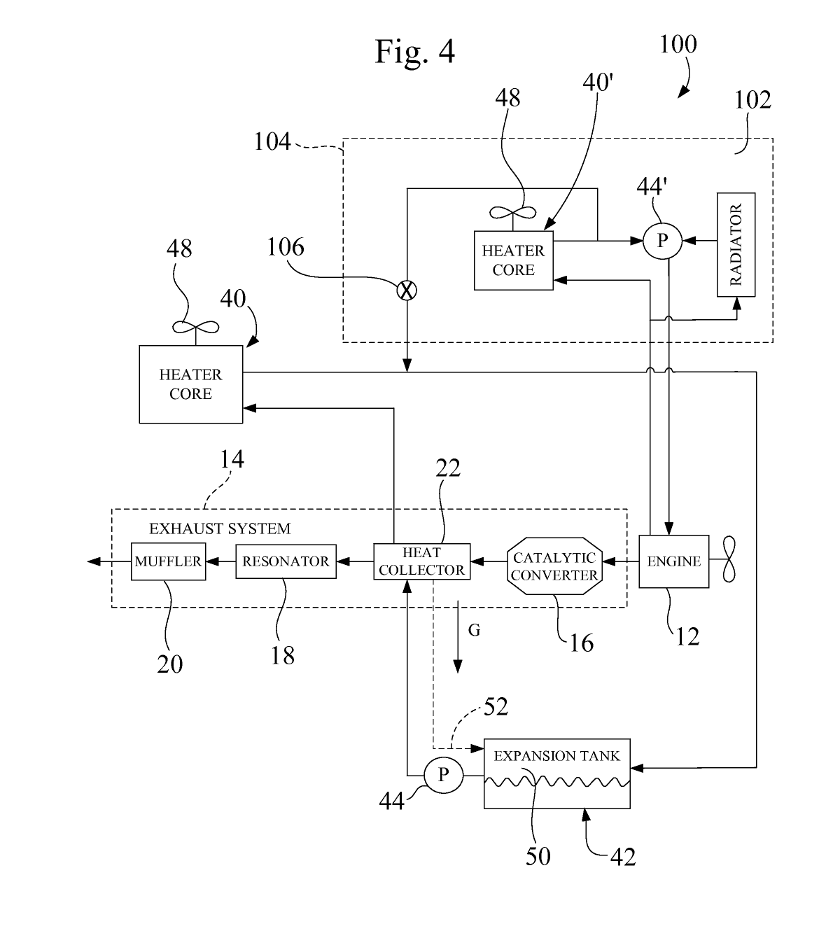

As illustrated, the pump is illustrated between the heat collector 22 and the expansion tank 42. In other embodiments, the pump 44 may be positioned between the expansion tank 42 and the heater core 40. It will be understood that the pump 44 may be located anywhere within the coolant flow path with the scope of the present teachings. In the same regard, the flow of coolant in the schematic illustration of FIG. 4 is clockwise (i.e., from the pump 44 to the heat collector 22, to the heater core 40, to the expansion tank 42 and back to the pump 44. In this way, heat is gather from the heat collector 22 and then transferred directly to the heater core 40 where it dissipates the heat for faster passenger cabin 46 or other component warm-up. It will be understood by those skilled in the art, however, that the flow of coolant may be in an opposite direction within the scope of the present teachings.

The heater core 40 may be located in proximity to a passenger cabin 46 of the motor vehicle. In this regard, the heater core 40 may be located directly in the passenger cabin 46. The heater core 40 is operatively associated with a fan 48. The fan 48 may be used to distribute heat from the heater core 40 throughout the passenger cabin 46 through an HVAC system for the comfort of the passengers. The fan 48 may also be used to directed heat from the heater core 40 to a windshield of the motor vehicle for defrosting the windshield.

Within the scope of the present teachings, it will be understood that the heater core 48 may be conventional in both construction and operation. In this regard, the heater core 48 may receive heated coolant and route the heated coolant through one or more winding tubes of a core. Fins attached to the core tube(s) may serve to increase surface area for heat transfer to air that is forced past the heater core 48 to thereby heat the passenger compartment.

The expansion tank 42 defines a chamber 50 for holding an amount of the coolant. The expansion tank 42 protects the system 10 from excess pressure. The tank 42 is partially filled with air. The compressibility of the air may conventionally absorb excess water pressure caused by thermal expansion. Furthermore, and as will be discussed below, the expansion tank 42 may retain coolant that drains from the heat collector 22 when it is not necessary to deliver further heat to the heater core 40.

In the embodiment illustrated, the expansion tank 42 is shown below the heat collector 22. In this manner, a gravitational force G acts in a direction from the heat collector 22 to the expansion tank 42. When coolant is not being routed through the system 10 to deliver heat to the heater core 40, coolant from the heat collector 22 may drain solely under gravitational force G from the heat collector 22 to the expansion tank 42. Condensation at the heat collector 22 will drip back down to the expansion tank 42.

In the embodiment illustrated, the coolant that drains from the heat collector 22 to the expansion tank 42 may drain along the normal flow path for the fluid during operation of the system. Alternatively or additionally, coolant may drain through a supplemental drain path 52. The drain path 52 may be a small diameter bypass tube inserted between the pump outlet and the expansion tank 42. The output pressure of the pump 44 may significantly exceed any resultant back pressure of the bypass tube such that a majority of the flow goes directly to the heat collector 22 and then to the heater core 40. When not in use, the back flow will return easily to the expansion tank 42 via this small diameter tube.

It will now be appreciated that the system 10 of the present teachings is operative to quickly deliver a source of heat from the exhaust system 14 to the passenger cabin 46 upon vehicle start-up. In operation, heated exhaust from the engine 12 is received by the catalytic converter 16. After the catalytic convert 16 acts on the exhaust, the exhaust passes through a pipe that is circumferentially surrounded by the heat collector 22. At this point, the temperature of the exhaust may be approximately 600 degrees Fahrenheit.

The system 10 of the present teachings may include one or more sensors 54. For example, a sensor 54 may sense a temperature of the heater core 40. Alternatively, sensors may sense a temperature of the passenger cabin 46, a temperature of the heater core 22 or a temperature at other points in the system 10.

Operation of the pump 44 may be controlled by the one or more sensors 54. In this regard, when the vehicle is started, the pump 44 is normally off. The pump 44 may begin to circulate coolant through the system 10 a predetermined minimum temperature is sensed by the sensor. For example, the pump 44 may begin to circulate coolant through the system when an ambient temperature is sensed by the sensor 54 that is below the predetermined minimum temperature. In one particular application, this predetermined minimum ambient temperature may be approximately 60 degrees Fahrenheit.

The pump 44 may be also controlled by the one or more sensors 54 to cease operation upon sensing of a temperature above a predetermined temperature. For example, pumping of coolant through the system 10 may be discontinued when a sensor senses a predetermined maximum temperature. For example, pumping of coolant through the system 10 may be discontinued when a sensor senses a cabin temperature of approximately 68-72 degrees Fahrenheit. Upon reaching the predetermined maximum temperature within the passenger cabin 46, it is no longer necessary to route supplemental heat to, the heater core 40. It will be understand that the predetermined minimum and maximum temperature may be altered for various applications within the scope of the present invention. It will also be understood that the predetermined minimum and maximum temperatures may be sensed at various other locations (e.g., at the heater core, etc.) When the pump 44 is pumping coolant through the system 10, coolant enters the inlet of the heat collector 22. The coolant circumferentially flows around the interior 26 and collects heat from the interior wall 28, the outer wall 30 and the fins 32. The heated coolant exits the heat collector 22 through the outlet 38 and is routed to the heater core 40. After the heater core 40, the cooled coolant is routed to the expansion tank 42 and then to the pump.

When pumping of coolant through the system 10 is stopped, it is important to drain or otherwise remove any coolant from the heat collector. In the embodiment illustrated, any fluid remaining in the heat collector 22 is allowed to drain from the heat collector back to the expansion tank 42 solely under gravitational force G. Additionally, any condensation in the heat collector 22 may drip back to the expansion tank 42. While not preferred, various valves may be employed within the system 10 within the scope of the present teachings.

Turning to FIG. 4, another system for providing heat to a cabin of a motor vehicle constructed in accordance with the present teachings is illustrated and generally identified at reference character 100. In view of the similarities between the system 10 and the system 100, common reference characters have been used to identify similar elements. The system 100 primarily differs from the system 10 in that the system 100 also extracts heat from the engine 12 of the vehicle for further heating of the passenger cabin 46.

In addition to the various elements shown and described with reference to FIG. 3, the system 100 additionally includes a second heater core 40′. As will be addressed below, in certain applications it may be desirable to utilize a combined heater core. The second heater core 40′ is in fluid communication with the vehicle engine 12. A second pump 44′ routes coolant warmed by the engine 12 to both a radiator 102 and the heater core 40′. The heater core 40′ may be identical in construction and operation to the heater core 40 described above. It will be understood that the radiator 102 may be of any structure well known in the art.

Heat is removed from the heated coolant by both the heater core 40′ and the radiator 102. The cooled coolant is routed back to the engine 12 for further cooling of the engine.

The heater core 40′, the radiator 102 and the pump 44′ effectively define a sub-system 104 of the system 100 for warming the passenger cabin 46. This sub-system 104 may be in fluid communication with the remainder of the system 10. In this manner, the coolant in the system 100 may be filled at a single point. A valve 106 may be located between the sub-system 104 and the remainder of the system 100.

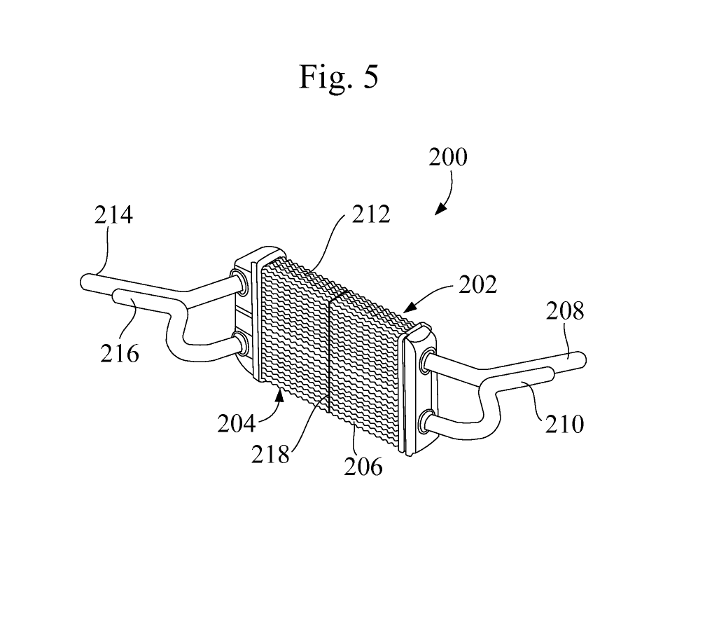

With reference to FIG. 5, a combination heater core constructed in accordance with the present teachings is illustrated and generally identified at reference character 200. In certain applications, it may be desirable to provide such a combination heater core 200 rather than two separate heater cores (e.g., as shown and described above with regarding to reference characters 40 and 40′).

As generally illustrated, the combination heater core 200 may include a first portion 202 and a second portion 204. The first portion 202 may include a first plurality of tubes 206 in fluid communication with a heat collector 22 through an inlet 208 and an outlet 210. Similarly, the second portion 204 may include a second plurality of tubes 212 in fluid communication with an engine 12 through and inlet 214 and an outlet 216. The first and second pluralities of tubes 206 and 212 may be horizontally spaced relative to one another and fluidly separated at a midline 218 of the combination heater core 200.

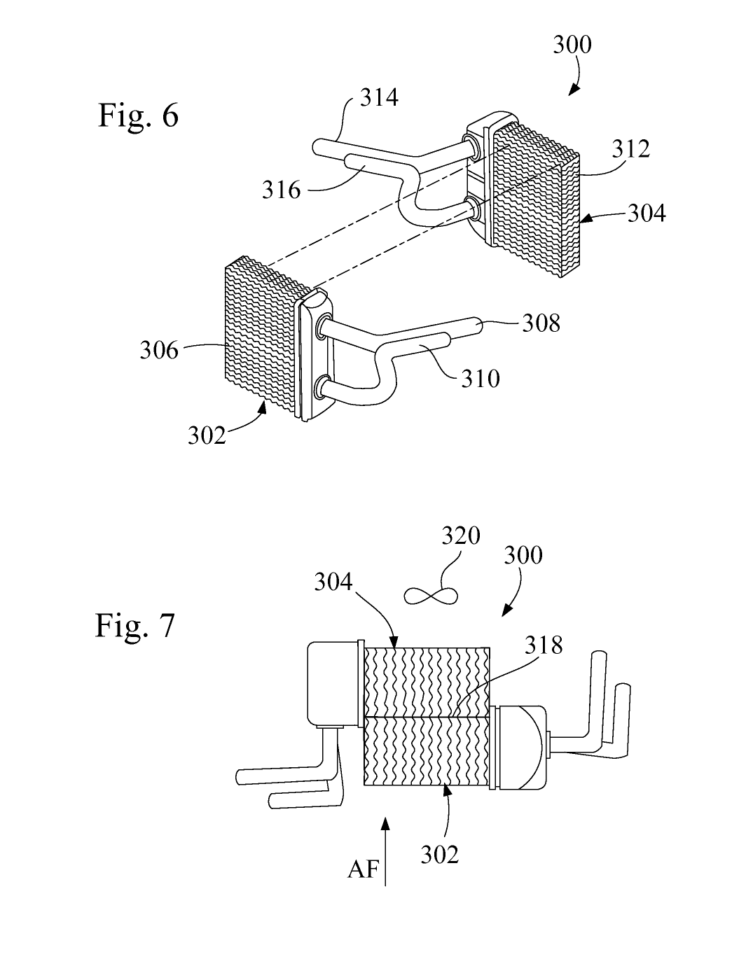

Turning to FIGS. 6 and 7, another combination heater core is illustrated and generally identified at reference character 300. Given the similarities between the combination heater core 200 and the combination heater core 300, common reference characters will be used to identify similar elements. The combination heater core 300 primarily differs from the combination heater core 200 in that a common airflow may pass through tubes of both portions of the heater core 300.

As generally illustrated, the combination heater core 300 may include a first portion 302 and a second portion 304. The first portion 302 may include a first plurality of tubes 306 in fluid communication with a heat collector 22 through an inlet 308 and an outlet 310. Similarly, the second portion 304 may include a second plurality of tubes 312 in fluid communication with an engine 12 through and inlet 314 and an outlet 316. The first and second pluralities of tubes 306 and 312 may be horizontally spaced relative to one another and fluidly separated at a midline 318 of the combination heater core 300. A common airflow drawn by a fan 320 may flow in a direction AF through both the first and second pluralities of tubes 306 and 312.

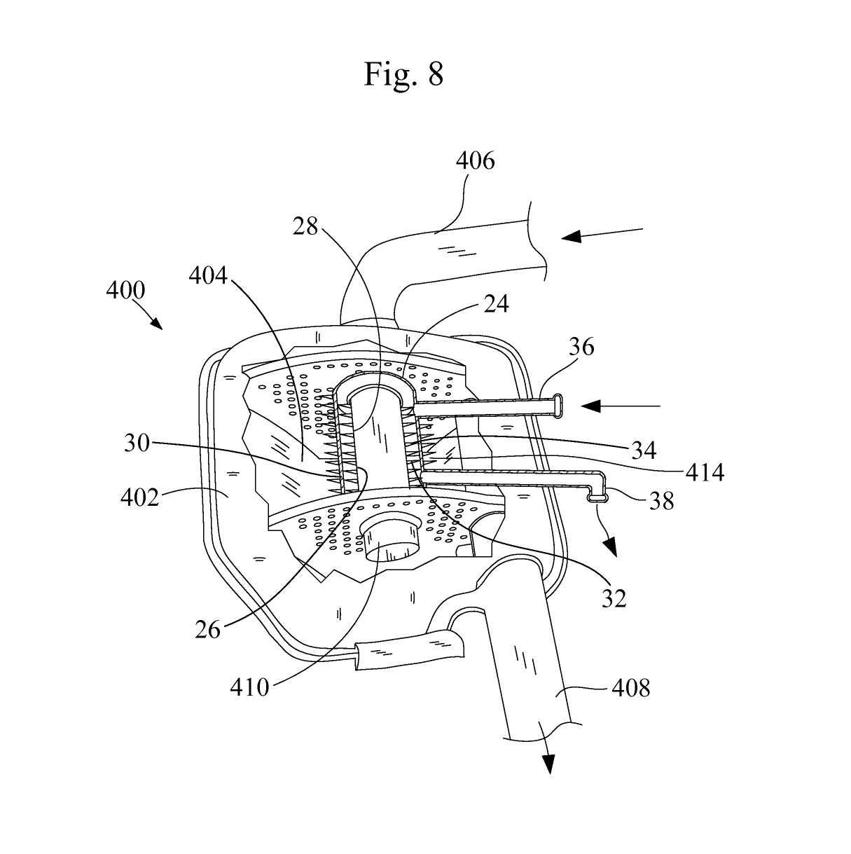

Turning to FIG. 8, an apparatus for quick warm-up of a motor vehicle constructed in accordance with the present teachings is illustrated and generally identified at reference character 400. As will be described, with the apparatus 400, the heat collector 22 of the present teachings may be incorporated into one of the conventional components of an exhaust system. As a result, the costs of the system may be reduced and packaging consideration alleviated. In this regard, the construction and operation of the heat collector 22 described above may be combined with the resonator 18 or the muffler 20, for example.

The apparatus 400 is generally shown to include a housing 402 defining a chamber 404. The apparatus 400 further includes an exhaust input port 406 and an exhaust output port 408. The input port 406 may receive heated exhaust from the catalytic converter 16. The outlet port 408 may deliver exhaust to a muffler 20 or a tailpipe (not shown).

An exhaust path extends from the exhaust input port 406 to the exhaust output port 408 and passes through the chamber 404. The exhaust path may be defined by a pipe 410. The chamber 404 may be a resonating chamber for tuning a sound of the exhaust.

A heat collector 22′ may be disposed in the chamber 404. The heat collector 22 may be operative to extract heat from the exhaust and may be in fluid communication with a heater core 40. In view of the similarities between the heat collector 22′ and the previously described heat collector 22, like reference characters will be used to identify similar elements.

The heat collector 22′ may include a jacket 24 for circumferentially surrounding the pipe 410 in fluid communication with the catalytic converter 16. The jacket 24 may be generally tubular in shape and may define an inner cavity 26 sized to receive the pipe. The jacket 24 may include an inner wall 28 radially spaced from an outer wall 30. The inner wall 28 directly receives heat from the pipe 410 extending from the catalytic converter. A chamber or fluid path 32 may be defined between the inner and outer walls 28 and 30.

A heat absorbing arrangement may be disposed in the fluid path 32 of the heat collector 22′. The heat absorbing arrangement may include a first plurality of fins 34. The fins 34 may be constructed of a suitable metal for receiving heat from the inner wall 28 and transferring a portion of the heat to the outer wall 30. The heat absorbing arrangement may further include a second plurality of fins 414 radially extending outward from the outer wall 30.

The heat collector 22′ is further illustrated to generally include an inlet 36 and an outlet 38. The inlet and outlet 36 and 38 are in fluid communication with the fluid path 32 of the heat collector 22. The inlet 36 is also in fluid communication with a heater core 40 for receiving a cooled fluid (i.e., coolant) from the heater core 40. The outlet 38 is also in fluid communication with an expansion tank 42 and a pump 44 for routing coolant warmed by the heat collector 22 back to the heater core 40.

A heat collector 22 or 22′ may similarly be incorporated into a combined housing with a muffler, catalytic converter, exhaust pipe, exhaust manifold, or any other component or pipe along a vehicle's exhaust path. Additionally, it will be understood that the present teachings, including the heat collector 22 or 22′, may be employed for applications not including a catalytic converter.

The above systems 10 and 100 are described in connection with the delivery of heat to the passenger cabin of a motor vehicle. Alternatively, the heat extracted from the exhaust system may be used to heat the engine upon start-up to reduce noxious gases or to heat the transmission to reduce drag while the transmission fluid is not sufficiently viscous. Where the system 10 or 100 employs a combination heater core, it may be desirable to heat the engine without delivering heat to the passenger cabin. For example, on a sunny, cool day, the passenger cabin may approach 100 degrees Fahrenheit or more, while the engine may be 50 degrees Fahrenheit at start-up.

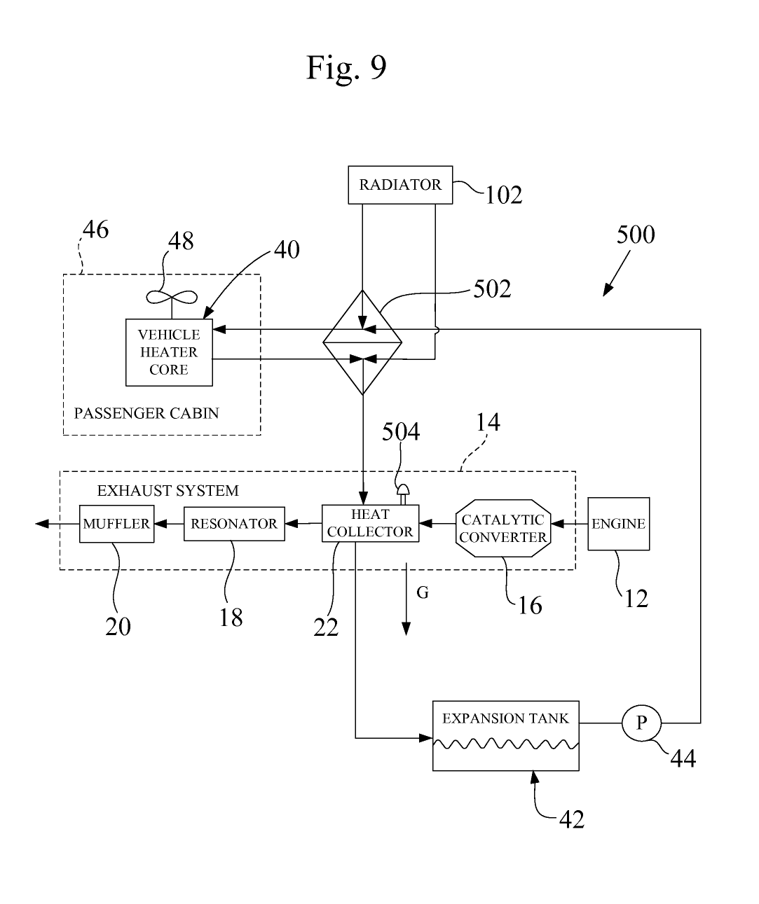

Turning to FIG. 9, another system for providing heat to a cabin of a motor vehicle constructed in accordance with the present teachings is illustrated and generally identified at reference character 500. In view of the similarities between the previously described systems 10 and 100, common reference characters have been used to identify similar elements with system 500. The system 500 primarily differs from the previously described systems 10 and 100 in that a single heater core 40 is disposed in the passenger cabin 46 for selectively receiving heat from the engine 12 and/or the exhaust system 14.

In the embodiment illustrated, the system 500 shares a common coolant. This sharing of coolant may extend coolant life through a closed system. Additionally, this sharing of coolant may allow for rejuvenation of the coolant routed through the exhaust system 14 with the main engine coolant.

The system 500 incorporates one or more valves for diverter valve 502 for selectively controlling the flow of coolant from the radiator 102 to the heater core 40, from the heat collector 22 to the heater core 40, from the heater core 40 to the radiator, and from the heater core 40 to the expansion tank 42. In the embodiment illustrated, the various flows of coolant is controlled by a common diverter valve 502. As illustrated, the diverter valve 502 is a four-way diverter valve 502. A pressure relief valve 504 may be incorporated into the heat collector 22.

In operation, the valve 504 may allow for coolant to flow from the heater core 40 to the heat collector 22 and the valve 504 may close the flow of coolant in undesired directions. With this embodiment, an additional heater core 40 is not necessary. Furthermore, weight may be saved by utilizing the vehicle's existing engine coolant.

The valve 504 may operate to totally prevent back flow in the case of a valve failure. Back flow may be prevented by inclusion of a redundant internal check valve. In this manner, a fail safe condition is provided.

The valve 504 may be controlled by a vehicle controller (not particularly shown). The controller may use a control algorithm established with look-up tables based on initial start of the engine (e.g., a time since last started), ambient temperature, cabin temperature, coolant temperature, and other inputs. It will be understood that the specific control algorithm is beyond the scope of the present teachings and that any suitable algorithm may be utilized.

As with the above systems 10 and 100, it will be understood that coolant may flow in the opposite direction to that shown in FIG. 9. Similarly, the pump 44 may be disposed at various locations within the system 500. Accordingly, it will now be appreciated by those skilled in the art that the present teachings provide systems for quick warm-up of a motor vehicle which are completely open. In this regard, the systems require no check valves but rather rely on gravitational force to drain fluid from a heat collector. As a result, a potential failure opportunity is completely eliminated.

While specific examples have been described in the specification and illustrated in the drawings, it will be understood by those skilled in the art that various changes may be made and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

1. A system for quick warm-up of a motor vehicle having an engine, an exhaust system and a passenger cabin, the system comprising:
a heat collector disposed in the exhaust system;
a heater core in proximity of the passenger cabin, the heater core in fluid communication with the heat collector for receiving a heated fluid from the heat collector; and
an expansion tank in fluid communication with the heat collector and the heater core; and
a pump for pumping the fluid from the heat collector to the heater core and from the heater core back to the heat collector.

2. The system for quick warm-up of a motor vehicle of claim 1, wherein the expansion tank is located below the heat collector such that fluid drains from the heat collector back to the expansion tank solely under gravitational force.

3. The system for quick warm-up of a motor vehicle of claim 1, wherein the heat collector includes an inner cylindrical wall and an outer cylindrical wall, the inner and outer cylindrical walls spaced apart from one another to define a heat collector fluid path therebetween.

4. The system for quick warm-up of a motor vehicle of claim 3, wherein the inner cylindrical wall of the heat collector circumferentially surrounds an exhaust pipe.

5. The system for quick warm-up of a motor vehicle of claim 3, further comprising a first plurality of fins disposed in the heat collector fluid path.

6. The system for quick warm-up of a motor vehicle of claim 5, further comprising a second plurality of fins radially extending outward from the outer wall.

7. The system for quick warm-up of a motor vehicle of claim 1, wherein the heat collector is disposed within a housing, the housing defining a resonator chamber.

8. An apparatus for quick warm-up of a motor vehicle having an engine and a passenger compartment, the apparatus comprising:
a housing defining a chamber;
an exhaust input port;
an exhaust output port;
an exhaust path extending from the exhaust input port to the exhaust output port and passing through the chamber; and
a heat collector disposed in the chamber and operative to extract heat from exhaust of the motor vehicle, the heat collector in fluid communication with a heater core.

9. The apparatus for quick warm-up of a motor vehicle of claim 8, wherein the chamber is a resonating chamber for tuning a sound of the exhaust.

10. The apparatus for quick warm-up of a motor vehicle of claim 8, wherein the chamber is a muffling chamber for muffling a sound of the exhaust.

11. The apparatus for quick warm-up of a motor vehicle of claim 8, wherein the exhaust path is defined by an exhaust pipe, the heat collector circumferentially surrounding the exhaust pipe.

12. The apparatus for quick warm-up of a motor vehicle of claim 8, in combination with the heater core, the apparatus further including a coolant path for circulating coolant from the heat collector, to the heater core and back to the heat collector.

13. The apparatus for quick warm-up of a motor vehicle of claim 11, wherein the heater core includes a heater jacket and a first plurality of fins within the heater jacket.

14. The apparatus for quick warm-up of a motor vehicle of claim 13, further comprising a second plurality of fins radially extending outward from the jacket.

15. A combination heater core for heating a passenger cabin of a motor vehicle, the combination heater core comprising:
a first portion for extracting heat from a first heat source; and
a second portion for extracting heat from a second heat source.

16. The combination heater core of claim 15, wherein the first heat source is exhaust from an engine of the motor vehicle.

17. The combination heater core of claim 16, wherein the second heat source is the engine.

18. The combination heater core of claim 17, in combination with a first coolant path for circulating coolant from the first portion to a heat collector extracting heat from the exhaust and back to the first portion.

19. The combination heater core of claim 18, in further combination with a second coolant path for circulating coolant from the second portion to the engine and back to the second portion.

20-28. (canceled)
